(19) United States
(12) Patent Application Publication
(10) Pub. No.: US 2003/0214509 A1
(43) Pub. Date: Nov. 20, 2003

(54) Digital image display device

(76) Inventor: Bradley L. Gotfried, Hobe Sound, FL (US)

Correspondence Address: Mark D. Passler, Akerman, Senterfitt & Eidson, P.A., P.O. Box 3188, West Palm Beach, FL, 33402-3188, US

(21) Appl. No.: 10/150,122

(22) Filed: May 16, 2002

(51) Int. Cl. G09G 5/02

(52) U.S. Cl. 345/589

(57) ABSTRACT

The invention concerns a portable digital image display device having a scanner for generating digital images, a disc media drive for reading digital images from a disc medium and writing digital images onto the disc medium and a display device for displaying digital images. Also, the invention concerns a digital image display device having a scanner for generating digital images, a multi-unit disc media storage wheel for storing a plurality of disc media and a disc media drive for reading digital images from at least one of the disc media stored on the storage wheel and writing digital images onto at least one of the disc media. The disc media drive can be an optical disc media drive, and the disc medium can be an optical disc medium.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

The present invention relates generally to digital multimedia systems, and more particularly to a digital image recording and display device.

2. Description of the Related Art

For many years, consumers have purchased cameras and other equipment to record special moments such as weddings, vacations or graduations. As an example, many individuals assemble photographs into a photo album, a keepsake that can be enjoyed for years. Unfortunately, most photographs fade over time and are susceptible to water damage or fire. Moreover, short of delivering one or more photographs contained in a photo album or supplying the entire album, there is no convenient way to share such treasures with friends or other family members.

While some people may use conventional scanners to convert a photograph into a digital file, such devices are bulky, and because they are primarily designed to be used with desktop computers, conventional scanners can be somewhat complicated to learn how to use. In addition, if a user wanted to record the scanned photographs onto a storage medium or e-mail the pictures, the user must typically invest in an expensive personal computer containing certain storage medium drives. Even worse, such a system is hardly portable and requires numerous power receptacles and electrical connections to perform. Thus, what is needed is a digital photo album that can permit users to enjoy digital photographs yet does not suffer from the drawbacks discussed above.

### SUMMARY OF THE INVENTION

The present invention concerns a portable digital image display device. The device includes a scanner for generating digital images, a disc media drive for reading digital images from a disc medium and writing digital images onto the disc medium and a display device for displaying digital images. In one arrangement, the disc media drive can be an optical disc media drive, and the disc medium can be an optical disc medium. In one aspect, the disc media drive can be a compact disc drive, and the disc medium can be a read only compact disc or a recordable compact disc. In another aspect, the disc media drive can be a digital video disc drive, and the disc medium can be a read only digital video disc or a recordable digital video disc.

In another arrangement, the digital image display device can further include structure for receiving, processing, recording and outputting audio. Also, the structure can include at least one speaker for outputting audio and at least one microphone for receiving audio. Additionally, the scanner and the display device can be self-contained components. The digital image display device can also include at least one port for receiving digital images from and for transmitting digital images to an external source and memory for storing digital images.

In another aspect, the display device can be a liquid crystal display or a plasma display. The digital image display device can also have a remote control circuit for permitting remote control of the display of digital images on the display device. This remote control circuit can include a user interface that can be detachably coupled to the device. In another arrangement, the digital image display device can include a power source in which the power source can be at least one disposable battery or at least one rechargeable battery

The invention also concerns a digital image display device having a scanner for generating digital images, a multi-unit disc media storage wheel for storing a plurality of disc media and a disc media drive for reading digital images from at least one of the disc media stored on the storage wheel and writing digital images onto at least one of the disc media. In one arrangement, the disc media drive can be an optical disc media drive, and each disc medium can be an optical disc medium.

Additionally, the disc media drive can be a compact disc drive, and each disc medium can be a read only compact disc or a recordable compact disc. The disc media drive can also be a digital video disc drive, and each disc medium can be a read only digital video disc or a recordable digital video disc. In this embodiment, the digital image display device can have at least one port for receiving digital images from and for transmitting digital images to an external display device. The device can also have memory for storing digital images and a power source in which the power source can be at least one disposable battery or at least one rechargeable battery.

### BRIEF DESCRIPTION OF THE DRAWINGS

FIG. 1A illustrates a simplified block diagram of a portable digital image display device in accordance with the inventive arrangements.

FIG. 1B illustrates a simplified block diagram of a another digital image display device in accordance with the inventive arrangements.

FIG. 2A illustrates a block diagram showing the components and associated control and data interfaces of the digital image display device of FIG. 1A in accordance with the inventive arrangements.

FIG. 2B illustrates a block diagram showing the components and associated control and data interfaces of the digital image display device of FIG. 1B in accordance with the inventive arrangements.

### DESCRIPTION OF THE PREFERRED EMBODIMENTS

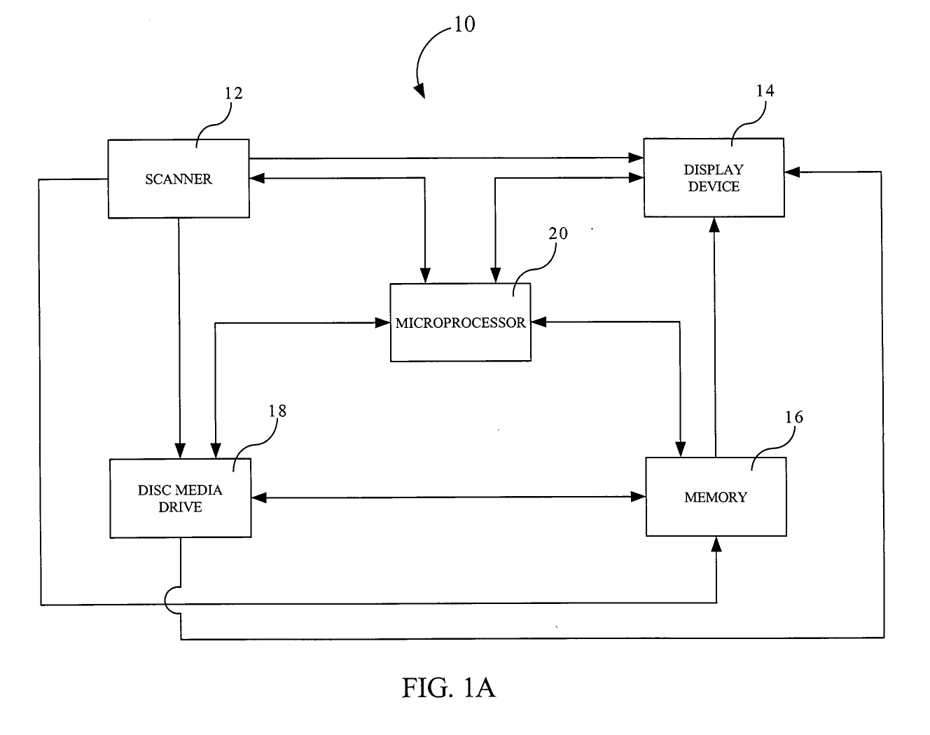

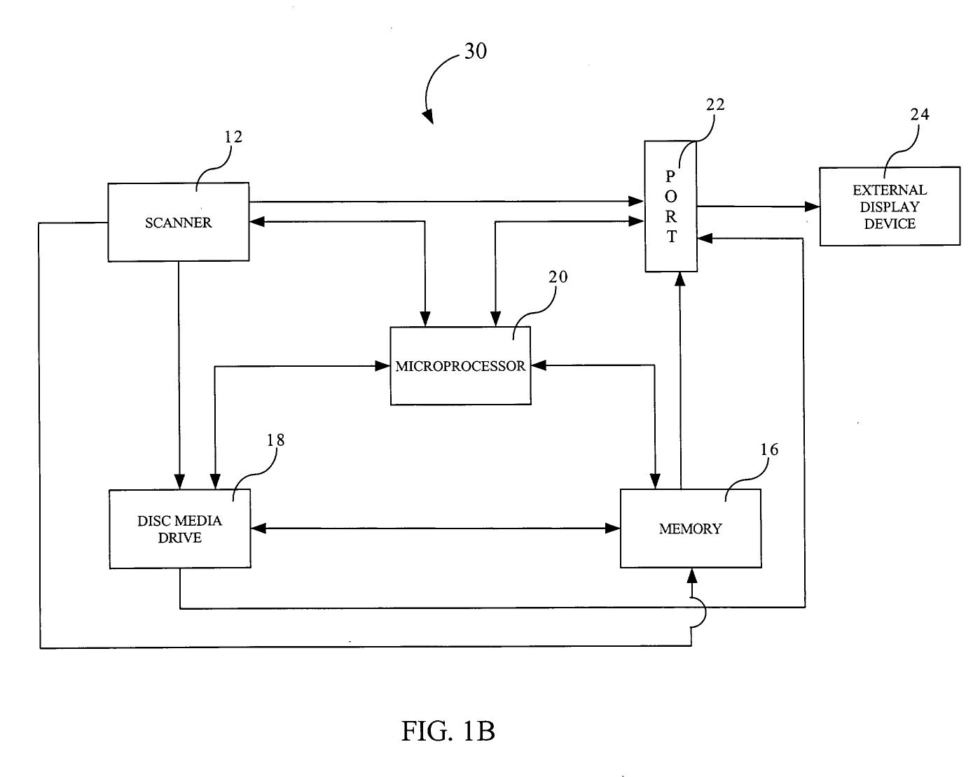

FIG. 1A shows a portable image display device 10 in accordance with the inventive arrangements. The device 10 can include a scanner 12, a display device 14, memory 16, a disc media drive 18 and a microprocessor 20. Control and data interfaces can also be provided to enable the transfer of data between the components of the device 10 and for permitting the microprocessor 20 to control such components. Suitable software or firmware can be provided in memory (not shown) for the operations performed by the microprocessor 20.

In one arrangement, the scanner 12 can be used to scan photographs or any other suitable document and to convert such tangible media into a digital image. The digital image can then be displayed on the display device 14 or can be transferred to memory 16 where it can be stored for later retrieval. Any digital images retrieved from memory 16 can be shown on the display device 14. In another arrangement, the digital image can be transferred from the scanner 12 to the disc media drive 18 where it can be recorded onto a suitable disc medium (not shown). In another arrangement, digital images stored on the disc medium can be transferred from the disc media drive 18 to the display device 14 or to memory 16. Additionally, digital images stored in memory 16 can be transferred to the disc media drive 18 where they can be recorded onto the disc medium. A more detailed description of this embodiment will be presented below.

FIG. 1B illustrates another digital image display device in accordance with the inventive arrangements. This digital image display device 30 also includes a scanner 12, memory 16, a disc media drive 18 and a microprocessor 20. Similar to the discussion relating to FIG. 1A, the scanner 12 can create digital images and transfer them to the disc media drive 18 where they can be recorded onto a suitable disc medium. In addition, the digital images can be transferred from the scanner 12 to memory 16. Digital images stored in memory 16 can also be sent to the disc media drive 18 for recording. The microprocessor 20 can control the operation of each of these components.

The device 30 can also include a port 22 and an external display device 24. The port 22 can receive digital images from the scanner 12, memory 16 or the disc media drive 18 and can send them to the external display device 24. The microprocessor 20 can also control the operation of the port 22. As with FIG. 1A, a more detailed description of the embodiment shown in FIG. 1B will be presented later. It is understood, however, that the invention is not limited to the examples discussed in relation to FIGS. 1A and 1B, as any other suitable configuration can be used in accordance with the inventive arrangements.

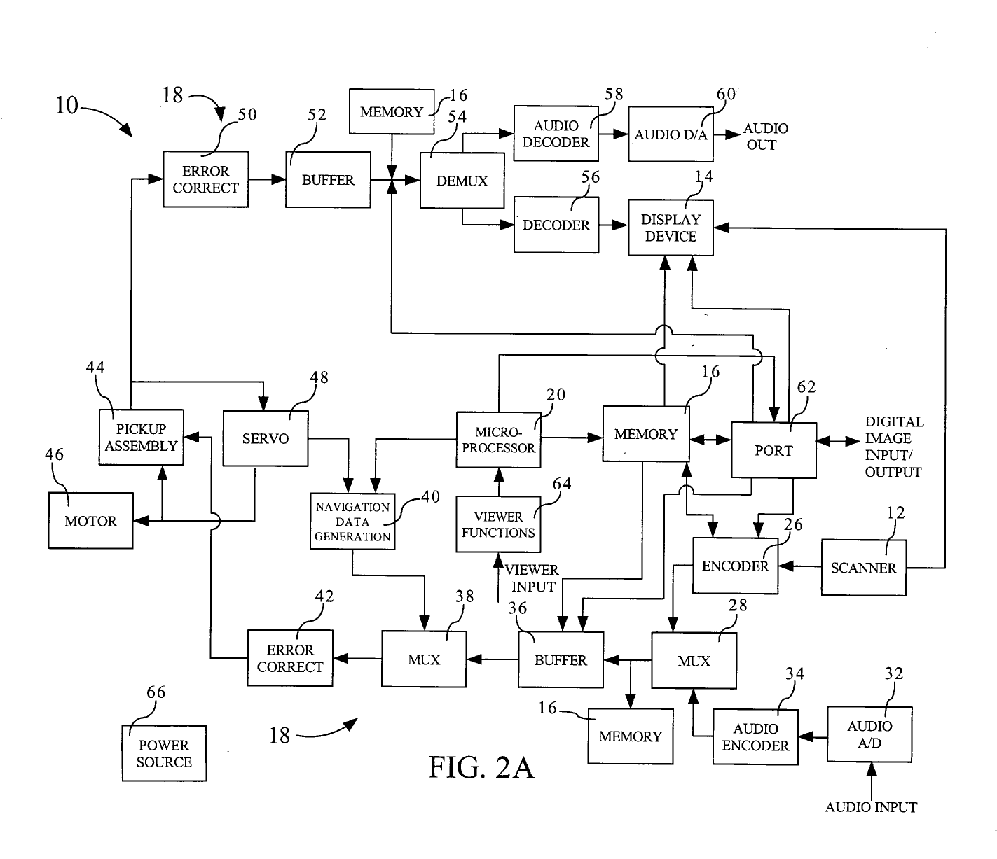

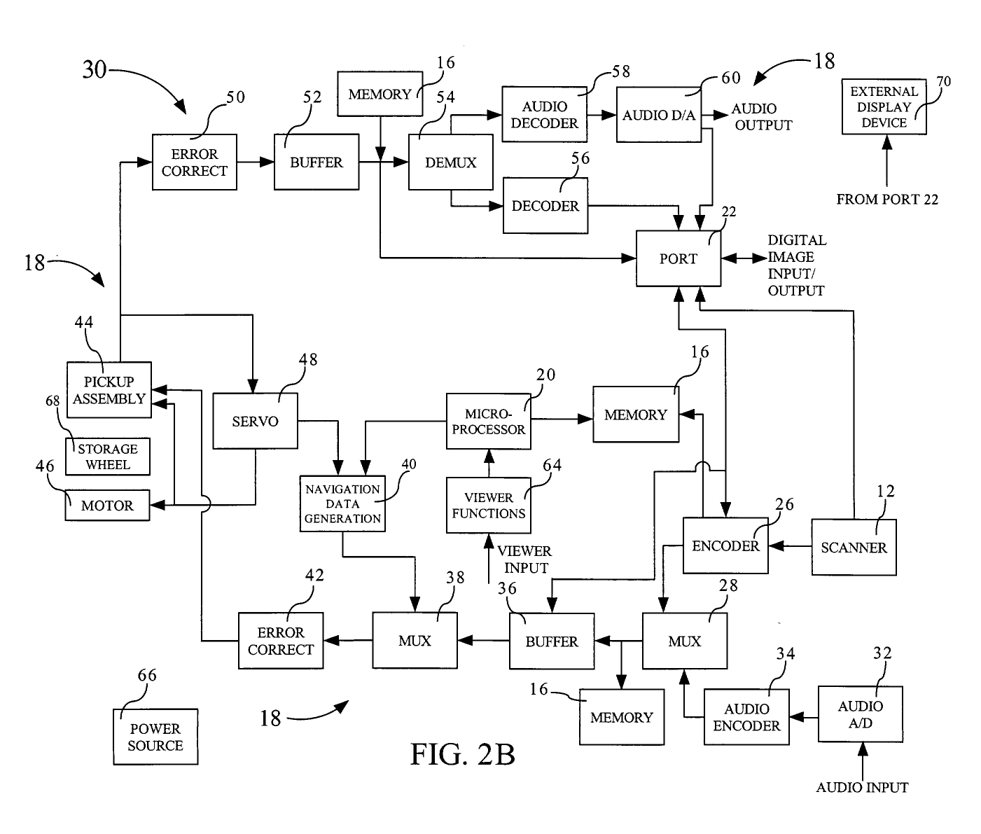

FIG. 2A is a block diagram illustrating in more detail the portable digital image display device 10 of FIG. 1A in accordance with the inventive arrangements. As shown, a user can create digital images from photographs or any other tangible medium by scanning the photographs or other medium with the scanner 12. These images can be further processed and immediately displayed on the display device 14. The display device 14 can be a liquid crystal display, a plasma display or any other suitable display. In addition, the scanner 12 and the display device 14 can be self-contained components in which the scanner 12 and the display device 14 are completely contained within the device 10 and no external connections are required for their operation. It is understood, however, that the invention is not limited in this regard, as external scanners or external display devices can also be used with the invention. For purposes of the invention, the term “external” can relate to any device, data source or data connection that is not under the control (through the microprocessor 20 or any other control circuitry) of the device 10. The display device 14 can also include a decorative cover (not shown) to protect the screen from scratches or other damage.

In another arrangement, an encoder 26 can be used to encode or compress the digital image, and the digital image can be stored in memory 16. The digital image can be encoded into, for example, a JPEG file, GIF file or any other suitable compression format. Memory 16 is not limited to any particular type of memory, as any suitable storage medium can be used.

In another arrangement, the digital image can be recorded onto a disc medium (not shown). For example, once its digitized, the digital image can be transferred to a multiplexer 28. In addition, the device 10 can include at least one microphone (not shown) for receiving audio. An audio analog to digital converter 32 can convert the audio into a digital signal, and an audio encoder 34 can encode the digitized audio signal. The encoded audio signal can then be multiplexed with the digital image at the multiplexer 28 thereby enabling a user to record a message with a corresponding digital image. In accordance with the option of combining audio with a digital image, the term digital image can mean visual data and audio data if applicable.

Once multiplexed, the digital image can be transferred to a buffer 36. If desired, the digital image can also be routed to memory 16 where it can be stored for later retrieval. Following the buffering step, the digital image can be multiplexed with navigation data at a multiplexer 38. A navigation data generation block 40 along with the microprocessor 20 can generate the navigation data. Subsequently, an error correction coding circuit 42 can error correct the digital image and can transfer the digital image to a pickup assembly 44. The pickup assembly 44 can include a laser (not shown) that can record the digital image onto the disc medium. A motor 46, which can cause the disc medium to spin during playback and recording, and a servo 48 (in combination with the pickup assembly 44) can guide the laser to a suitable recording location on the disc medium.

Should the user desire to playback a digital image, the servo 46, the motor 48 and the pickup assembly 44 can direct the laser to the location on the disc medium where the digital image is stored. Once read from the disc medium, an error correction coding circuit 50 can error correct the digital image, and the digital image can be buffered at a buffer 52. The digital image can then be demultiplexed at a demultiplexer 54, i.e., the visual data can be separated from any associated audio components. A decoder 56 can decode the digital image, and the digital image can be displayed on the display device 14.

Additionally, an audio decoder 58 can decode any associated audio, and an audio digital to analog converter 60 can convert the digitized audio signal into an analog signal. The device 10 can include one or more speakers (not shown) for broadcasting the audio signal. In another arrangement and as shown in FIG. 2A, any digital images stored in memory 16 can be directed to the demultiplexer 54 and the decoding portion of the disc media drive 18 if a user wishes to display compressed images from memory 16.

All or portions of the encoder 26, the audio encoder 34, the multiplexer 28, the buffer 36, the multiplexer 38, the error correction coding circuit 42, the pickup assembly 44, the servo 46 and the motor 48 can be considered part of the disc media drive 18. Moreover, all or portions of the error correction coding circuit 50, the buffer 52, the demultiplexer 54, the decoder 56 and the audio encoder 58 can be considered part of the disc media drive 18. In one arrangement, the disc media drive can be a compact disc drive, and the disc medium can be a read only compact disc or a recordable compact disc. The disc media drive can also be a digital video disc drive, and the disc medium can be a read only digital video disc or a recordable digital video disc. It must be noted, however, that the invention is not so limited. For example, the disc media drive 18 can be any other suitable drive for reading data from or writing data to a storage medium, and the disc medium is not limited to any particular type of disc. Those of ordinary skill in the art will also appreciate the compatibility of compact discs in a digital video disc drive.

The device 10 can also include one or more ports 62 for receiving data from and transmitting data to an external source. For example, the port 62 can receive a digital image from an external source such as the Internet and can transfer the digital image to several destinations in the device 10. If the digital image is already properly encoded for recording, then the digital image can be transferred from the port 62 to the buffer 36 and can be recorded onto the disc medium pursuant to the above discussion. The encoder 26 can encode the digital image, if necessary, prior to the recording step.

In another arrangement, the digital image, if it is in a suitable format for display, can be transferred from the port 62 to the display device 14 for immediate display. Alternatively, if it is necessary to decode the digital image, then the image can be transferred to the demultiplexer 54 and on to the decoding portion of the disc media drive 18. Any digital images received by the port 62 can also be transferred to memory 16 for storage and for later retrieval. The port 62 can also be used to transmit digital images generated by the device 10 to an external source. The port 62 can be any suitable connection for transmitting digital images to and receiving digital images from an external source. Although not limited in this regard, examples of the port 62 can include a conventional modem or a USB port.

The device 10 can also include a viewer functions buffer 64 for receiving user instructions and transferring such commands to the microprocessor 20. In one arrangement, the user can signal the viewer functions buffer 64 and the microprocessor 20 via a remote control circuit (not shown). The remote control circuit can employ any suitable type of signaling means such as infrared or RF. The remote control circuit can include a user interface component (not shown) that can be detachably coupled to any suitable location on the device 10.

The device 10 can also include a power source 66. In one arrangement, the power source 66 can be one or more disposable batteries or one or more rechargeable batteries. Moreover, the power source can include an external connection for receiving power from an external source such as a standard electrical receptacle.

FIG. 2B is a block diagram illustrating in more detail the digital image display device 30 of FIG. 1B in accordance with the inventive arrangements. Similar to the portable digital image display device 10 of FIG. 2A, the digital image display device 30 of FIG. 2B can contain the scanner 12, memory 16, the disc media drive 18 including each of the components associated with it and as described in relation to FIG. 2A, the microprocessor 20 and the associated viewer functions buffer 64. Likewise, the device 30 can include the audio analog to digital converter 32, one or more microphones (not shown), one or more speakers (not shown) and the audio digital to analog converter 60. The device can also have the power source 66, which can be one or more disposable batteries or one or more rechargeable batteries or can have an external connection for receiving power from an external source.

In one arrangement, disc media drive 18 of the device 30 can have a multi-unit disc media storage wheel 68 for storing a plurality of disc media. The storage wheel 68 can store any suitable type of disc media such as a read only compact disc, recordable compact disc, read only digital video disc or recordable digital video disc. It is understood, however, that the invention is not limited to the foregoing examples, as other disc media can be stored by the storage wheel 68. The motor 46 can be used to move the storage wheel 68 to permit the laser contained in the pickup assembly 44 to read from or write to the desired disc medium.

In another arrangement, the port 22 can receive a digital image from a portion of the disc media drive 18 outputting a playback signal, memory 16 or the scanner 12. As noted earlier, the term “digital image” can include both visual data and audio data if applicable. Each of these inputs can be transferred to an external source such as the external display device 24. The external display device 24 can be any suitable display device for displaying the decoded digital images. The device 30 can also include any necessary circuitry for encoding the decoded digital images for display on the external display device 70 such as an NTSC encoder or any other suitable processing circuitry.

The digital image received from the output portion of the disc media drive 18 can be either a decoded signal or can remain an encoded signal in which the digital image is transferred to the port 22 prior to being decoded. Moreover, the input received from the scanner 12 can be directly from the scanner 12 or can be encoded by the encoder 26 before being transmitted to the port 22. Any input from memory 16 can also either be an encoded image or a decoded or uncompressed image.

Conversely, the port 22 can receive digital images from a variety of external sources and can forward these images to any suitable portion of the input side of the disc media drive 18 or memory 16. For example, the port 22 can receive JPEG files from the Internet and can transfer this file to the buffer 36 for recording onto one of the disc media on the storage wheel 68 or memory 16. If necessary, the encoder 26 can encode any digital images received from an external source through the port 22. It is understood that the invention is not limited to any of the foregoing examples, as the external source can be any other suitable device or data source capable of receiving digital images from or transmitting digital images to the port 22 and that is not under the control of the device 30.

Although the present invention has been described in conjunction with the embodiments disclosed herein, it should be understood that the foregoing description is intended to illustrate and not limit the scope of the invention as defined by the claims.

What is claimed is:

1. A portable digital image display device, comprising:
a scanner for generating digital images;
a disc media drive for reading digital images from a disc medium and writing digital images onto said disc medium; and
a display device for displaying digital images.

2. The device according to claim 1, wherein said disc media drive is an optical disc media drive and said disc medium is an optical disc medium.

3. The device according to claim 2, wherein said disc media drive is a compact disc drive and said disc medium is a disc medium selected from the group comprising a read only compact disc or a recordable compact disc.

4. The device according to claim 2, wherein said disc media drive is a digital video disc drive and said disc medium is a disc medium selected from the group comprising a read only digital video disc or a recordable digital video disc.

5. The device according to claim 1, further comprising structure for receiving, processing, recording and outputting audio.

6. The device according to claim 5, wherein said structure includes at least one speaker for outputting audio and at least one microphone for receiving audio.

7. The device according to claim 1, wherein said scanner and said display device are self-contained components.

8. The device according to claim 1, further comprising at least one port for receiving digital images from and for transmitting digital images to an external source.

9. The device according to claim 1, further comprising memory for storing digital images.

10. The device according to claim 1, wherein said display device is a liquid crystal display.

11. The device according to claim 1, wherein said display device is a plasma display.

12. The device according to claim 1, further comprising a remote control circuit for permitting remote control of the display of digital images on said display device;
wherein said remote control circuit includes a user interface that is detachably coupled to said device.

13. The device according to claim 1, further comprising a power source;
wherein said power source is a power source selected from the group comprising at least one disposable battery or at least one rechargeable battery.

14. A digital image display device, comprising:
a scanner for generating digital images;
a multi-unit disc media storage wheel for storing a plurality of disc media; and
a disc media drive for reading digital images from at least one of said disc media stored on said storage wheel and writing digital images onto at least one of said disc media.

15. The device according to claim 14, wherein said disc media drive is an optical disc media drive and each said disc medium is an optical disc medium.

16. The device according to claim 15, wherein said disc media drive is a compact disc drive and each said disc medium is a disc medium selected from the group comprising a read only compact disc or a recordable compact disc.

17. The device according to claim 15, wherein said disc media drive is a digital video disc drive and each said disc medium is a disc medium selected from the group comprising a read only digital video disc or a recordable digital video disc.

18. The device according to claim 14, further comprising at least one port for receiving digital images from and for transmitting digital images to an external display device.

19. The device according to claim 14, further comprising memory for storing digital images.

20. The device according to claim 14, further comprising a power source;
wherein said power source is a power source selected from the group comprising at least one disposable battery or at least one rechargeable battery.

21. A portable digital image display device, comprising:
a self-contained scanner for generating digital images;
an optical disc media drive for reading digital images from an optical disc medium and writing digital images onto said optical disc medium;
a self-contained display device for displaying digital images;
structure for receiving, processing, recording and outputting audio;
wherein said structure includes at least one speaker for outputting audio and at least one microphone for receiving audio;
at least one port for receiving digital images from and for transmitting digital images to an external source;
memory for storing digital images;
a remote control circuit for permitting remote control of the display of digital images on said display device;
wherein said remote control circuit includes a user interface that is detachably coupled to said device; and
a power source;
wherein said power source is a power source selected from the group comprising at least one disposable battery or at least one rechargeable battery.

22. The device according to claim 21, wherein said optical disc media drive is a compact disc drive and said disc medium is a disc medium selected from the group comprising a read only compact disc or a recordable compact disc.

23. The device according to claim 21, wherein said optical disc media drive is a digital video disc drive and said disc medium is a disc medium selected from the group comprising a read only digital video disc or a recordable digital video disc.

24. A digital image display device, comprising:
a self-contained scanner for generating digital images;
a multi-unit optical disc media storage wheel for storing a plurality of optical disc media;
an optical disc media drive for reading digital images from at least one of said optical disc media stored on said storage wheel and writing digital images onto at least one of said optical disc media;
at least one port for receiving digital images from and for transmitting digital images to an external display device;
memory for storing digital images; and
a power source;
wherein said power source is a power source selected from the group comprising at least one disposable battery or at least one rechargeable battery.

25. The device according to claim 24, wherein said optical disc media drive is a compact disc drive and said disc medium is a disc medium selected from the group comprising a read only compact disc or a recordable compact disc.

26. The device according to claim 24, wherein said optical disc media drive is a digital video disc drive and said disc medium is a disc medium selected from the group comprising a read only digital video disc or a recordable digital video disc.
